(19) United States
(12) Patent Application Publication
(10) Pub. No.: US 2025/0332733 A1
(43) Pub. Date: Oct. 30, 2025

(54) MULTI-FUNCTION ROBOTIC END EFFECTOR, SYSTEMS, AND METHODS

(71) Applicant: ProcessChamp, LLC, Columbus, OH (US)

(72) Inventor: George Ghanem, Columbus, OH (US)

(21) Appl. No.: 19/188,679

(22) Filed: Apr. 24, 2025

Related U.S. Application Data
(60) Provisional application No. 63/638,811, filed on Apr. 25, 2024.

(51) Int. Cl. B25J 9/16; B25J 15/06; B25J 19/02

(52) U.S. Cl. CPC B25J 9/1697; B25J 15/0608; B25J 15/0616; B25J 19/023

(57) ABSTRACT

System and methods for automatically selecting an end effector function for material handling are disclosed. A robot includes end effectors of different type. A controller receives image data from one or more machine vision components of a part at a workspace for handing by the robot. The controller analyzes the image data to determine characteristics of the part. Based, at least in part, on the analyzed image data, including the determined characteristics, the controller determines at least one of the end effectors to utilize for the part.

### CROSS-REFERENCE TO RELATED APPLICATIONS

This application claims the benefit of U.S. provisional patent application Ser. No. 63/638,811 filed Apr. 25, 2024, which is hereby incorporated by reference as if fully restated herein.

### TECHNICAL FIELD

Exemplary embodiments relate generally to end effectors, such as gripping devices, for robots, such as industrial robots, having multiple functions, as well as related systems and methods.

### BACKGROUND AND SUMMARY OF THE INVENTION

Various types and kinds of robots are known. Some such robots are designed to handle various materials and/or components as part of a manufacturing process. Often, these robots have end effectors (e.g., grippers, welding torches, drills, etc.) that are specific to the task the robot is intended to accomplish and/or the part to be handled. Because of this specialization, end effectors or robots generally must be replaced or modified when a new task is to be accomplished, a new part is to be handled, the manufacturing process changes, the part changes, or the like.

A multi-function robot end effector is provided which increases flexibility in manufacturing. The end effector is configured for gripping parts (e.g., materials and/or components of an assembly or subassembly) such as for handling and manipulation. The end effector may comprise at least one magnet, at least one vacuum subsystem, and at least one mechanical gripping component. The end effector may be part of a larger robot and/or robot system, such as an industrial robot, and/or flexible manufacturing system.

The manufacturing system and/or robot may include one or more sensors, cameras, machine vision systems, combinations thereof, or the like. In exemplary embodiments, without limitation, the system comprises artificial intelligence (“AI”) software configured to learn to recognize parts, part orientations, surface textures, combinations thereof, or the like, and operate the end effector to maximize success in handling the part. For example, without limitation, the AI software may be utilized to capture images of the part to be handled and orient the end effector, select a particular one or more of the end effectors functionalities to utilize (e.g., magnets, vacuum, mechanical gripping component), move the end effector, combinations thereof, or the like to best handle and move the part. The machine vision system may be configured to record the workspace, such as to evaluate success in handling the part (e.g., moved correctly, dropped, dislodged, shifted, combinations thereof, or the like) and provide feedback regarding the same to the AI software, such as to alter and improve the computer algorithm(s) over time.

Alternatively, or additionally, parts may sometimes be picked up (whether by the components, systems, and/or methods shown and/or described herein or otherwise—e.g., conventional components, systems, and/or methods) in an incorrect orientation. This may be problematic for subsequent placement, especially when part of a fixtureless manufacturing process and/or system. Provided herewith is a bracket for re-orienting parts as needed. Also provided herewith are systems and methods for re-orienting parts, such as on an as-needed basis to facilitate increased precision in subsequent placement. A re-orientation bracket may include a substantially V-shaped receiving portion elevated from a base. A slot may be provided in at least one side of the “V” of the receiving portion to receive a portion of a part. The slot may be provided within a larger channel, which may comprise a shaped depression and/or taper within the same side of the “V” around at least two or three sides of the slot.

Part securement components may be positioned adjacent to the slots to secure parts placed thereat. The part securement components may be permanently or semi-permanently installed and may comprise vacuum systems, magnets, physical support structures, or the like. In this way, a part may be positioned at the slot and secured by the part securement component associated with the re-orientation bracket. A respective part may be secured at a respective bracket by the bracket alone or in conjunction with an associated one of the part securement component. Regardless, this may allow the robot to temporarily release the part and re-grasp it for movement into a correct orientation. This may be important to accommodate functional limitations of the robot (e.g., degrees of freedom, movement constraints).

The part may be imaged before placement at the re-orientation bracket (e.g., before or after initial pickup) or after, such as while placed at the re-orientation bracket. Where re-orientation is needed, the part may be picked up and re-oriented by a same or different robot. Securement and/or release of the part may be coordinated by electronic communication between the robot and the part securement component, for example.

The same or different imaging may be used to capture feature locations on the part in question, which may be subsequently transmitted to an assembly software module to determine need for re-orientation and/or offsets during subsequent placement within the assembly, such as in a fixtureless manner.

The present disclosures may provide subsequent placement with a high degree of accuracy, such as within a 1-5 mm, by way of non-limiting example.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical, similar, or equivalent features, and wherein:

FIG. 1 is a rear perspective view of an exemplary multi-function end effector;

FIG. 2 is another rear perspective view of the end effector of FIG. 1;

FIG. 3 is another rear perspective view of the end effector of FIG. 1;

FIG. 4 is a top view of the end effector of FIG. 1;

FIG. 5 is a front view of the end effector of FIG. 1;

FIG. 6 is a rear view of the end effector of FIG. 1;

FIG. 7 is a flow chart with exemplary logic for operating the end effector of FIG. 1;

FIG. 8 is schematic of a system using the end effector of FIG. 1 on a robot with a machine vision subsystem, such as with the logic of FIG. 7;

FIG. 9 is a flow chart with exemplary logic for operating the system of FIG. 8;

FIG. 10 is a perspective view of an exemplary re-orientation bracket for use with the system of FIG. 8 and method of FIG. 9 with an exemplary first part;

FIG. 11 is another perspective view of the re-orientation bracket of FIG. 10 with an exemplary second part;

FIG. 12 is a perspective view of the re-orientation bracket of FIGS. 10-11 in isolation;

FIG. 13 is a detailed, perspective view of exemplary re-orientation brackets used as part of an exemplary system for use with the method of claim 9 in exemplary use; and

FIG. 14 is a perspective view of the system of FIG. 11 in other exemplary use.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

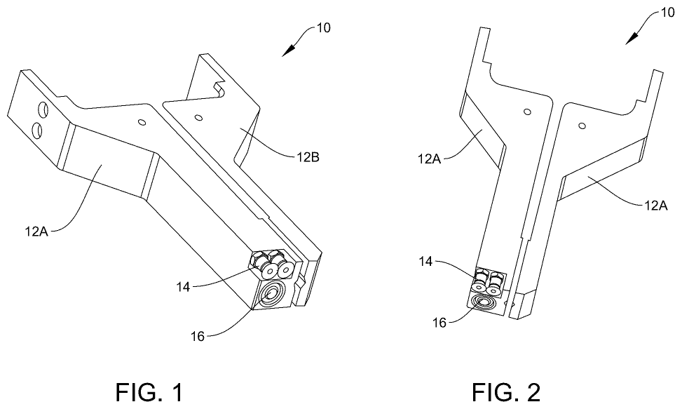

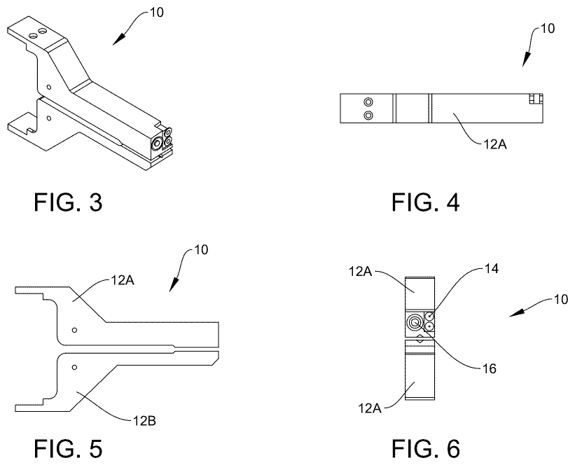

FIG. 1 through FIG. 6 illustrate an exemplary multi-function end effector 10. The end effector 10 may comprise a first mechanical gripping component 12A and a second mechanical gripping component 12B. The first and second mechanical gripping components 12A, 12B may be moveable relative to each other, such as by way of one or more motors, springs, levers, gears, pistons, hydraulics, combinations thereof, or the like. The gripping components 12 may be configured to selectively grip and release parts. The gripping components 12 may comprise fingers, claws, hooks, combinations thereof, or the like. The gripping components 12 may, for example without limitation, be vertically displaceable, moveable, and/or translatable. Any number, arrangement, and/or type of mechanical gripping components 12 may be utilized.

The end effector 10 may comprise one or more vacuum subsystems 14. The vacuum subsystem(s) 14 may comprise one or more hose attachments, channels, combinations thereof, or the like. Preferably, the vacuum subsystem(s) 14 comprises a hose attachment portion at a proximal end of a first mechanical gripping component 12A and a channel which extends within the first mechanical gripping component 12A to one or more part contacting surfaces at a distal portion of the first mechanical gripping component 12A. One or more apertures may be provided at the part contacting surface(s), such as to facilitate transmission of the generated vacuum. The hose attachment portion may be attached to a hose and/or vacuum pump to operate the vacuum subsystem. Any number, type, and/or arrangement of vacuum subsystems 14 and/or components thereof may be utilized.

The end effector 10 may comprise one or more magnets 16. The magnet(s) 16 may comprise permanent magnets and/or electromagnets. The magnet(s) 16 may be located at the proximal portion of the first mechanical gripping component 12A in exemplary embodiments, without limitation. Transmission of the magnetic field may occur naturally through the first mechanical gripping component 12A, such as because the first mechanical gripping component 12A comprises one or more ferrous materials, in exemplary embodiments without limitation. Such as where electromagnets are utilized, electromagnetic fields may be generated upon attachment of one or more power sources to the end effector 10, such as to one or more electromagnetic receiving components located at the proximal end of the first mechanical gripping component 12A. Any number, type, and/or arrangement of magnets 16 and/or components thereof may be utilized.

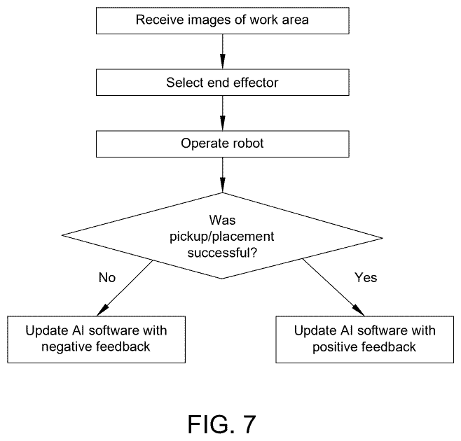

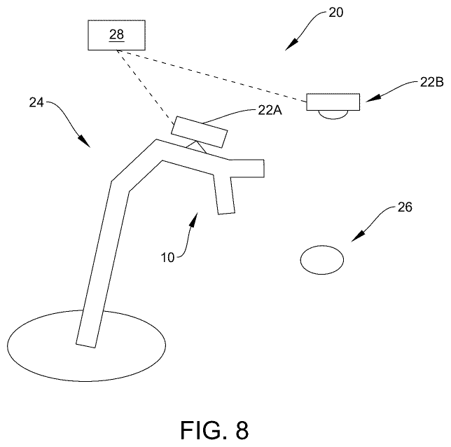

FIG. 7 illustrates exemplary logic for utilizing the end effector 10, such as part of a system 20 as illustrated in FIG. 8. The end effector 10 may be installed to a robot 24, which may be an industrial robot, by way of non-limiting example. The robot 24 may comprise, or be associated with, one or more machine vision components 22A, 22B. The machine vision components 22 may comprise one or more cameras, sensors, object recognition software routines, lasers, optical range finders, combinations thereof, or the like. The machine vision components 22 may comprise, or be associated with, one or more controllers 28. The controllers 28 may comprise programmable logic controllers (PLCs), processors, electronic storage devices (non-transitory), combinations thereof, or the like.

Data received from the machine vision component(s) 22, such as of a work area, may be received at the controller(s) 28. The controller 28 may be configured to recognize a type, orientation, location, combinations thereof, or the like of one or more objects 26, such as parts for an assembly, within the work area.

The controllers 28 may be configured to command the end effector 10 to operate to pick up and/or move the object(s) 26 based on the data received from the machine vision components 22. The controllers 28 may be configured to move the mechanical gripping component(s) 12, activate the vacuum subsystem 12, activate the magnet(s) 16, combinations thereof, or the like, such as based on a type, orientation, or the like of the object 26 detected. For example, without limitation, the controller 28 may reference a lookup table of weightings and/or values based on characteristics of the object 26 detected (e.g., type, shape, orientation, surface texture, material, combinations thereof, or the like). Some or all such characteristic information may be pre-supplied. Others may be detected by sensor(s), such as the machine vision component(s) 22.

By way of non-limiting example, where the object 26 has a particularly smooth surface, such as a flat, smooth, metal surface, the controller 28 may determine that the vacuum subsystem 12 may be well suited for object 26 handling and activate the same, such as by itself and/or in combination with the magnet(s) 16, such as in instances where the material is determined to comprise ferrous material(s). In such an example, the controller 28 may decide to not use, or only mildly clamp the object 26 with the mechanical gripping component(s) 12, such as because the smooth object may be difficult to grip and/or to minimize surface marring. The controller 28 may be configured to operate in a wide variety of ways based on the data received and/or derived.

In exemplary embodiments, without limitation, the controller 28 comprises one or more artificial intelligence (AI) algorithms. The controller 28 may be configured to receive data from the machine vision component(s) 22, such as after or while the object 26 is gripped and/or moved in the work area. If the object 26 appears to be secured and is successfully placed where desired, the controller 28 may provide such positive feedback to the AI algorithm(s), which may cause, for example, weights assigned to certain data in a lookup table to be adjusted upward. The weights may be associated with detected object type, object orientation, end effector 10 function to utilize (e.g., mechanical, vacuum, magnet), combinations thereof, or the like. If the object 26 appears to be unsecured and/or is not successfully placed where desired, the controller 28 may provide such negative feedback to the AI algorithm(s), which may cause, for example, weights assigned to certain data in a lookup table to be adjusted downward.

In exemplary embodiment, without limitation, a score may be derived for each detected object 26. The end effector to be used may be selected based on the determined score. Weights/values may be adjusted based on received feedback. Exemplary lookup tables and algorithm are provided below for operation of the controller 28, by way of non-limiting example in this regard.

TABLE 1
lookup table for objects 26

| Weight/value | Shape | Material | Orientation |
|---|---|---|---|
| 1 | Multi-member | Wood | Short end up |
| 2 | Multi-featured | Plastic | Long end up |
| 3 | Cuboid | Composite | Other |
| 4 | Spherical | Metal | Flat on surface |
| 5 | Unknown | Unknown | Unknown |

$$Score = ( Shape \times W 1 ) + ( Material \times W 2 ) + ( Orientation \times W 3 )$$

Algorithm 1 - scoring detected objects 26

| Score | End Effector |
|---|---|
| <5 | Mechanical |
| >5 but <10 | Mechanical and vacuum |
| >10 but <15 | Mechanical and magnet |
| >15 | Mechanical, magnet, |
| | and vacuum |

Sometimes, parts 26 may be picked up (whether by the end effectors 10, systems 20, and/or methods shown and/or described with regard to any one or more of FIGS. 1-8 or otherwise—e.g., conventional components, systems, and/or methods) in an incorrect orientation. This may be problematic for subsequent placement.

The weight values, characteristics, scores, algorithms, and/or end effort 10 choices are exemplary and are not intended to be limiting. The data shown and/or described herein may be stored in different formats and/or utilized in different ways.

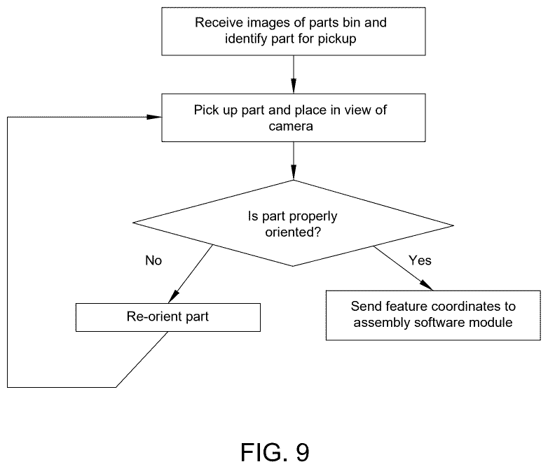

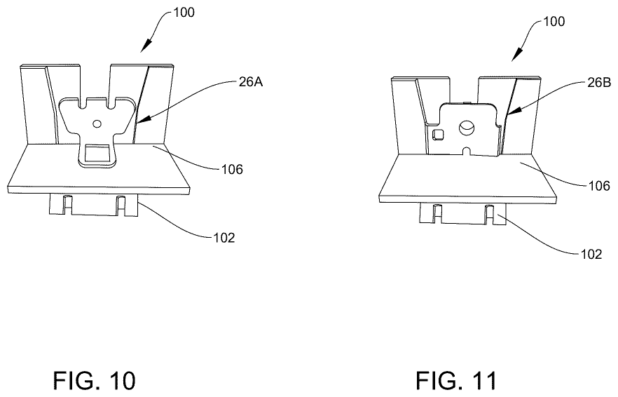

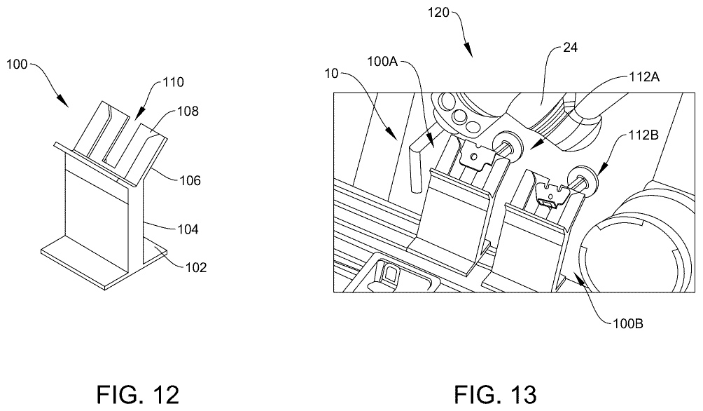

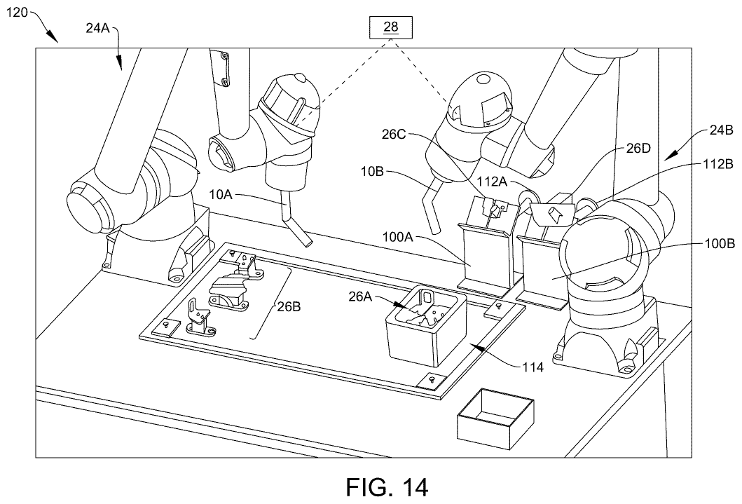

As illustrated with particular regard to at least FIG. 9 through FIG. 14, a system 120 may include one or more re-orientation brackets 100 for re-orienting parts 26 as needed. Each re-orientation bracket 100 may include a substantially V-shaped receiving portion 106. The receiving portion 106 may be elevated from a base 102, such as by a column 104. A slot 110 may be provided in at least one side of the “V” of the receiving portion 106, such as to receive a portion of a part 26. The slot 110 may be provided within a larger channel 108, which may comprise a shaped depression and/or taper within the same side of the “V” of the receiving portion 106, around at least one, two, or three sides of the slot 110.

Part securement components 112 may be positioned adjacent to the re-orientation brackets 100, such as at or adjacent to the slots 108 thereof. The part securement components 112 may be configured to secure parts 26 placed at the reorientation brackets 100, such as upon activation of the part securement components 112 and/or physical contact with the same. The part securement components 112 may be permanently or semi-permanently installed. The part securement components 112 may comprise vacuums, magnets, physical support structures, combinations thereof, or the like. The part securement components 112 may be the same or different from the end effectors 10. For example, without limitation, the part securement components 112 may comprise multiple end effector functions (e.g., magnet, vacuum, mechanical gripping) which may be selected based upon images of the part 26 taken pre- or after initial pickup. Alternatively, the part securement components 112 may comprise a single end effector function.

Regardless, a part 26 may be positioned at the slot 108 and secured by the part securement component 112 associated with the re-orientation bracket 100. This may allow the robot 24 to temporarily release the part 26 and re-grasp it, such as for movement into a correct orientation.

The system 120 may comprise one or more machine vision components 22, such as those shown and/or described with respect to FIGS. 7 and/or 8 by way of non-limiting example. For example, each of the robots 24A, 24B may comprise a camera 22A and/or one or more centralized camera 22B may be utilized. The system 120 may comprise one or more controllers 28, such as those shown and/or described with respect to FIGS. 7 and/or 8 by way of non-limiting example. The controller(s) 28 and/or machine vision components 22 may be in electronic communication with one or more of the robots 24, machine vision components 22, and/or part securement components 112.

The steps shown and/or described herein may be controlled by way of the controller(s) 28, such as based on data from the machine vision component(s) 22.

A part 26 may be identified, such as of a first set of one or more parts 26 at a bin 114 at a work area, such as by one of the cameras 22. The identified part 26 may be picked up by one of the robots 24. A determination may be made if the identified part 26 needs re-orientation. Such a determination may be made before placement atone of the re-orientation brackets 100A, 100B (e.g., from the initial imaging data), or after, such as by picking up and moving the identified part 26 by one of the robots 24 into view of one of the cameras 22. Regardless, where re-orientation is needed, the identified part 26 may be placed at one of the re-orientation brackets 100. This may allow the robot 24 to temporarily release the part 26, such as for picking up by a same or different robot 24 for re-orientation of the part 26. This is sometimes required due to physical limitations on the robots' 24 movement capabilities, the need to gather and/or orient multiple parts, timing of assembly, and/or or other needs during the manufacturing process.

Alternatively, or additionally, such decisions on need for re-orientation may be made based on images taken of the part 26 such as at the re-orientation brackets 100. Positioning the parts 26 in this fashion may provide a clearer image and more consistent background, such as to enhance feature extraction for proper machine vision analysis.

Securement and/or release of the part 26, such as by the robot(s) 24 and/or part securement components 112, may be coordinated by electronic communication between the robot(s) 26, the part securement component(s) 112, and/or sensors, by way of non-limiting example.

The same or different imaging may be used to capture feature locations on the part 26. These features may be subsequently transmitted to an assembly software module (e.g., hardware and/or software shown and/or described in US Pub. No. 2022/0016762, incorporated by reference by way of non-limiting example) to determine need for re-orientation and/or offsets during subsequent placement within the assembly. Such modules (including related hardware and/or software) may be part of one or more of the machine vision components (e.g., camera(s) 22) or separate therefrom.

Part 26 re-orientation may be accomplished in other exemplary embodiment, without limitation, without the use of the brackets 100, such as by operation of the robot(s) 24 alone and/or with set-down and pick up at another surface, such as a different bracket, work surface, combinations thereof, or the like.

As the controller(s) 28 may be configured to select a particular end effector 10 to utilize (e.g., magnet, vacuum, mechanical gripping, etc.) based on the images and/or the part 26 orientation, the decision on which end effector 10 to utilize may be adjusted where the part 26 is re-oriented, such as by way of the optional re-orientation brackets 100, where used. Part 26 orientation may be derived, at least in part, from captured images of the part 26.

The present disclosures may provide subsequent placement of parts 26, such as in another location, relative to another part 26, in a partial assembly, or the like, with a high degree of accuracy, such as within a 1-5 mm, by way of non-limiting example.

Exemplary embodiments of these disclosures are provided below, without limitation.

Embodiment A1—A system for automatically selecting an end effector function for material handling, said system comprising: a robot comprising end effectors of different type; one or more machine vision components; a controller in electronic communication with the one or more machine vision components and the robot, said controller comprising software instructions, which when executed, configure the controller to: receive image data from the one or more machine vision components of a part at a workspace for handling by the robot; analyze said image data to determine characteristics of said part; and based, at least in part, on said analyzed image data, including said characteristics, determine at least one of the end effectors to utilize for the part.

Embodiment A2—The system of embodiment A1 wherein: said end effectors comprises a mechanical gripper, a vacuum subsystem, and one or more magnets.

Embodiment A3—The system of any one of embodiment A2 wherein: said end effectors are integrated into a unitary subassembly.

Embodiment A4—The system of any one of embodiments A2-A3 wherein: said mechanical gripper comprises a first mechanical gripping component, a second mechanical gripping component, and at least one motor for moving the first mechanical gripping component relative to the second mechanical gripping component; said one or more magnets comprise one or more magnets located at the first mechanical gripping component; and said vacuum subsystem comprises tubes extending through the first mechanical gripping component.

Embodiment A5—The system of any one of embodiments A1-A4 wherein: said characteristics comprise at least two of: a shape, a material, and an orientation of the part.

Embodiment A6—The system of embodiment A4 wherein: the characteristics comprise each of: the shape, the material, and the orientation of the part.

Embodiment A7—The system of any one of embodiments A1-A6 wherein: the controller is configured to: assign a value to each of the characteristics; generate a score based, at least in part, on the values of the characteristics; and select the at least one of the end effectors to utilize for the part based, at least in part, on the score.

Embodiment A8—The system of embodiment A7 wherein: the controller is configured to generate the score using a weighted summation.

Embodiment A9—The system of any one of embodiments A1-A8 wherein: the controller is configured to: select more than one of the end effectors to utilize for the part where the score is above a first threshold; and select all of the end effectors to utilize for the part where the score is above a second threshold.

Embodiment A10—The system of any one of embodiments A1-A9 wherein: the robot comprises an articulating arm; the end effectors are located at a distal end of the articulating arm; and each of the one or more machine vision components comprises a camera.

Embodiment A11—The system of embodiment A10 wherein: at least one of the cameras is connected to the articulating arm of the robot in view of the end effectors.

Embodiment A12—The system of any one of embodiments A10-A11 wherein: at least one of the cameras is mechanically independent of the robot and positioned overhead to view the workspace.

Embodiment A13—The system of embodiments A1-A12 wherein: the controller is configured to command operation of the robot causing manipulation of the part within the workspace using the at least one of the end effectors.

Embodiment A14—The system of any one of embodiments A1-A13 wherein: the controller is configured to, following command of the operations of the robot causing manipulation of the part receive further image data from the one or more machine vision components of the part at the workspace for handling; analyze said further image data to determine if the part was satisfactorily manipulated at the workspace, including a comparison of data indicating post-manipulation part orientation with pre-determined data indicating expected post-manipulation part orientation; and based, at least in part, on said analyzed further image data, including said comparison, provide negative or positive feedback.

Embodiment A15—The system of any one of embodiments A1-A14 wherein: the controller is configured to: assign a value to each of the characteristics; select the at least one of the end effectors to utilize for the part based, at least in part, on the values; and adjust the values assigned to each of the characteristics for the part based, at least in part, on the feedback.

Embodiment A16—The system of any one of embodiments A1-A15 wherein: the controller comprises one or more artificial intelligence (AI) algorithms.

Embodiment A17—The system of any one of embodiments A1-A16 wherein: the values are stored in tables in association with the characteristics.

Embodiment A18—The system of any one of embodiments A1-17 further comprising: a reorientation bracket configured to receive the part in a first one of the orientations, wherein operations of the robot causing manipulation of the part within the workspace using the at least one of the end effectors includes grasping the part using the at least one of the end effectors, releasing the part at the reorientation bracket in the first one of the orientations from the at least one of the end effectors, further operating the robot to reorient the end effectors, and grasping the part at the reorientation bracket a second time.

Embodiment B1—A system for automatically selecting an end effector function for material handling, said system comprising: a robot comprising an articulating arm and end effectors of different type located at a distal end of the articulating arm, wherein: said effectors comprises a mechanical gripper, a vacuum subsystem, and one or more magnets integrated into a single component; said mechanical gripper comprises a first mechanical gripping component, a second mechanical gripping component, and at least one motor for moving the first mechanical gripping component relative to the second mechanical gripping component; said one or more magnets comprise one or more magnets located at the first mechanical gripping component; and said vacuum subsystem comprises tubes extending through the first mechanical gripping component; one or more machine vision components including at least one camera mechanically affixed to the articulating arm of the robot in view of the end effectors and at least one other camera mechanically independent of the robot and positioned overhead to view a workspace; a reorientation bracket configured to receive the part in a first orientation; a controller in electronic communication with the one or more machine vision components and the robot, said controller comprising software instructions and at least one artificial intelligence algorithm, which when executed, configure the controller to: receive image data from the one or more machine vision components of a part at the workspace for handling; analyze said image data to determine characteristics of said part, said characteristics comprising a shape, a material, and an orientation of the part, wherein said analysis includes: assigning a value to each of the characteristics, wherein the values are stored in tables in association with the characteristics; and generating a score based, at least in part, on the values of the characteristics using a weighted summation; and based, at least in part, on said analyzed image data, selecting at least one of the end effectors to utilize for the part, including selecting the at least one of the end effectors to utilize for the part based, at least in part, on the score, including by selecting more than one of the end effectors to utilize for the part where the score is above a first threshold and selecting all of the end effectors to utilize for the part where the score is above a second threshold; command operation of the robot causing manipulation of the part within the workspace using the at least one of the end effectors, including grasping the part using the at least one of the end effectors, releasing the part at the reorientation bracket in the first orientation, further operating the robot to reorient the end effectors, and grasping the part at the reorientation bracket a second time; receive further image data from the one or more machine vision components of the part at the workspace for handling; analyze said further image data to determine if the part was satisfactorily manipulated at the workspace, including a comparison of data indicating post-manipulation part orientation with pre-determined data indicating expected post-manipulation part orientation; based, at least in part, on said analyzed further image data, including said comparison, provide negative or positive feedback; and adjust the values assigned to each of the characteristics for the part based, at least in part, on the feedback.

Embodiment C1—A method for automatically selecting an end effector function for material handling, said method comprising: electronically receiving, at a controller, image data from one or more machine vision components at a workspace of a part at the workspace for handling; electronically and automatically, by way of the controller, analyzing said image data to determine characteristics of said part; based, at least in part, on said analyzed image data, and by way of the controller, electronically and automatically determining at least one of end effectors of a robot to utilize for manipulating the part; and by way of the controller, electronically and automatically, commanding the robot to utilize the at least one of the end effectors to grasp the part and manipulate the part within the workspace.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

Certain operations described herein may be performed by one or more electronic devices. Each electronic device may comprise one or more processors, electronic storage devices, executable software instructions, combinations thereof, and the like configured to perform the operations described herein. The electronic devices may be general purpose computers or specialized computing devices. The electronic devices may comprise personal computers, smartphones, tablets, databases, servers, or the like. The electronic connections and transmissions described herein may be accomplished by one or more wired or wireless connectively components (e.g., routers, modems, ethernet cables, fiber optic cable, telephone cables, signal repeaters, and the like) and/or networks (e.g., internets, intranets, cellular networks, the world wide web, local area networks, and the like). The computerized hardware, software, components, systems, steps, methods, and/or processes described herein may serve to improve the speed of the computerized hardware, software, systems, steps, methods, and/or processes described herein. The electronic devices, including but not necessarily limited to the electronic storage devices, databases, controllers, or the like, may comprise and/or be configured to hold, solely non-transitory signals.

What is claimed is:

1. A system for automatically selecting an end effector function for material handling, said system comprising:
a robot comprising end effectors of different type;
one or more machine vision components;
a controller in electronic communication with the one or more machine vision components and the robot, said controller comprising software instructions, which when executed, configure the controller to:
receive image data from the one or more machine vision components of a part at a workspace for handling by the robot;
analyze said image data to determine characteristics of said part; and
based, at least in part, on said analyzed image data, including said characteristics, determine at least one of the end effectors to utilize for the part.

2. The system of claim 1 wherein:
said end effectors comprises a mechanical gripper, a vacuum subsystem, and one or more magnets.

3. The system of claim 2 wherein:
said end effectors are integrated into a unitary subassembly.

4. The system of claim 3 wherein:
said mechanical gripper comprises a first mechanical gripping component, a second mechanical gripping component, and at least one motor for moving the first mechanical gripping component relative to the second mechanical gripping component;
said one or more magnets comprise one or more magnets located at the first mechanical gripping component; and
said vacuum subsystem comprises tubes extending through the first mechanical gripping component.

5. The system of claim 1 wherein:
said characteristics comprise at least two of: a shape, a material, and an orientation of the part.

6. The system of claim 5 wherein:
the characteristics comprise each of: the shape, the material, and the orientation of the part.

7. The system of claim 1 wherein:
the controller is configured to:
assign a value to each of the characteristics;
generate a score based, at least in part, on the values of the characteristics; and
select the at least one of the end effectors to utilize for the part based, at least in part, on the score.

8. The system of claim 7 wherein:
the controller is configured to generate the score using a weighted summation.

9. The system of claim 7 wherein:
the controller is configured to:
select more than one of the end effectors to utilize for the part where the score is above a first threshold; and
select all of the end effectors to utilize for the part where the score is above a second threshold.

10. The system of claim 1 wherein:
the robot comprises an articulating arm;
the end effectors are located at a distal end of the articulating arm; and
each of the one or more machine vision components comprises a camera.

11. The system of claim 10 wherein:
at least one of the cameras is connected to the articulating arm of the robot in view of the end effectors.

12. The system of claim 11 wherein:
at least one other of the cameras is mechanically independent of the robot and positioned overhead to view the workspace.

13. The system of claim 1 wherein:
the controller is configured to command operation of the robot causing manipulation of the part within the workspace using the at least one of the end effectors.

14. The system of claim 13 wherein:
the controller is configured to, following command of the operations of the robot causing manipulation of the part:
receive further image data from the one or more machine vision components of the part at the workspace for handling;
analyze said further image data to determine if the part was satisfactorily manipulated at the workspace, including a comparison of data indicating post-manipulation part orientation with pre-determined data indicating expected post-manipulation part orientation; and
based, at least in part, on said analyzed further image data, including said comparison, provide negative or positive feedback.

15. The system of claim 14 wherein:
the controller is configured to:
assign a value to each of the characteristics;
select the at least one of the end effectors to utilize for the part based, at least in part, on the values; and
adjust the values assigned to each of the characteristics for the part based, at least in part, on the feedback.

16. The system of claim 15 wherein:
the controller comprises one or more artificial intelligence (AI) algorithms.

17. The system of claim 16 wherein:
the values are stored in tables in association with the characteristics.

18. The system of claim 13 further comprising:
a reorientation bracket configured to receive the part in a first one of the orientations, wherein said operations of the robot causing manipulation of the part within the workspace using the at least one of the end effectors includes grasping the part using the at least one of the end effectors, releasing the part at the reorientation bracket in the first one of the orientations from the at least one of the end effectors, further operating the robot to reorient the end effectors, and grasping the part at the reorientation bracket a second time.

19. A system for automatically selecting an end effector function for material handling, said system comprising:
a robot comprising an articulating arm and end effectors of different type located at a distal end of the articulating arm, wherein:
said effectors comprises a mechanical gripper, a vacuum subsystem, and one or more magnets integrated into a single component;
said mechanical gripper comprises a first mechanical gripping component, a second mechanical gripping component, and at least one motor for moving the first mechanical gripping component relative to the second mechanical gripping component;
said one or more magnets comprise one or more magnets located at the first mechanical gripping component; and
said vacuum subsystem comprises tubes extending through the first mechanical gripping component;
one or more machine vision components including at least one camera mechanically affixed to the articulating arm of the robot in view of the end effectors and at least one other camera mechanically independent of the robot and positioned overhead to view a workspace;
a reorientation bracket configured to receive the part in a first orientation;
a controller in electronic communication with the one or more machine vision components and the robot, said controller comprising software instructions and at least one artificial intelligence algorithm, which when executed, configure the controller to:
receive image data from the one or more machine vision components of a part at the workspace for handling;
analyze said image data to determine characteristics of said part, said characteristics comprising a shape, a material, and an orientation of the part, wherein said analysis includes:
assigning a value to each of the characteristics, wherein the values are stored in tables in association with the characteristics; and
generating a score based, at least in part, on the values of the characteristics using a weighted summation; and
based, at least in part, on said analyzed image data, selecting at least one of the end effectors to utilize for the part, including selecting the at least one of the end effectors to utilize for the part based, at least in part, on the score, including by selecting more than one of the end effectors to utilize for the part where the score is above a first threshold and selecting all of the end effectors to utilize for the part where the score is above a second threshold;
command operation of the robot causing manipulation of the part within the workspace using the at least one of the end effectors, including grasping the part using the at least one of the end effectors, releasing the part at the reorientation bracket in the first orientation, further operating the robot to reorient the end effectors, and grasping the part at the reorientation bracket a second time;
receive further image data from the one or more machine vision components of the part at the workspace for handling;
analyze said further image data to determine if the part was satisfactorily manipulated at the workspace, including a comparison of data indicating post-manipulation part orientation with pre-determined data indicating expected post-manipulation part orientation;
based, at least in part, on said analyzed further image data, including said comparison, provide negative or positive feedback; and
adjust the values assigned to each of the characteristics for the part based, at least in part, on the feedback.

20. A method for automatically selecting an end effector function for material handling, said method comprising:
electronically receiving, at a controller, image data from one or more machine vision components at a workspace of a part at the workspace for handling;
electronically and automatically, by way of the controller, analyzing said image data to determine characteristics of said part;
based, at least in part, on said analyzed image data, and by way of the controller, electronically and automatically determining at least one of end effectors of a robot to utilize for manipulating the part; and
by way of the controller, electronically and automatically, commanding the robot to utilize the at least one of the end effectors to grasp the part and manipulate the part within the workspace.
